(19) United States
(12) Patent Application Publication
(10) Pub. No.: US 2014/0092395 A1
(43) Pub. Date: Apr. 3, 2014

(54) METHOD FOR AUTOMATED INLINE DETERMINATION OF THE REFRACTIVE POWER OF AN OPHTHALMIC LENS

(71) Applicant: Novartis AG, Basel (CH)

(72) Inventors: Susanne Fechner, Aschaffenburg (DE); Roger Biel, Aschaffenburg (DE)

(73) Assignee: Novartis AG, Basel (CH)

(21) Appl. No.: 14/038,490

(22) Filed: Sep. 26, 2013

Related U.S. Application Data
(60) Provisional application No. 61/707,225, filed on Sep. 28, 2012.

(51) Int. Cl. G01M 11/02

(52) U.S. Cl. CPC G01M 11/0228; G01M 11/0207
USPC 356/517; 356/124

(57) ABSTRACT

A method for an automated inline determination of the refractive power of an ophthalmic lens (5) including providing an inspection cuvette having an optically transparent bottom (21) and having a concave inner surface (210) and containing the ophthalmic lens (5) immersed in a liquid, and providing a light source (42) and a wavefront sensor (6) including a detector. The light coming from the light source (42) and having passed the ophthalmic lens (5) contained in the inspection cuvette and impinging on the detector generates signals at the detector. By comparing the signals generated at the detector with predetermined signals representative of a reference refractive power, the refractive power of the ophthalmic lens (5) is thereby determined.

This application claims the benefit under 35 USC §119 (e) of U.S. provisional application Ser. No. 61/707,225 filed Sep. 28, 2012, incorporated herein by reference in its entirety.

### TECHNICAL FIELD

The present invention relates to a method for an automated inline determination of the refractive power of an ophthalmic lens.

### BACKGROUND

The manufacturing of ophthalmic lenses, in particular of single wear soft contact lenses which are used only once and which are disposed of after use, may be performed in a fully automated manufacturing line with the aid of reusable molds. In order to ensure top quality of the so manufactured contact lenses, the contact lenses are optically inspected inline in an inspection module of the fully automated manufacturing line for the presence of bubbles, edge defects, flaws or inclusions, etc. which would render the contact lenses unacceptable.

During set-up of the manufacturing line, for example before starting a new production lot, new molds are installed on the manufacturing line. Prior to starting “actual” production of contact lenses which are distributed to customers, a predetermined number of “dummy” contact lenses are produced with each of the newly installed molds in order to verify that the newly installed molds are properly arranged so that contact lenses are produced which have the desired specifications. The “dummy” contact lenses are inspected offline to make sure that the contact lenses manufactured with the newly installed molds have the desired specifications including refractive power of the contact lenses. After inspection, the “dummy” lenses are disposed of. Due to the large number of individual molds being present in the manufacturing line, several hundred up to a few thousand of “dummy” lenses end up as waste even if they fulfill the desired specifications. More importantly, however, the time needed for producing and inspecting the predetermined number of “dummy” lenses prior to starting “actual” production of contact lenses which are distributed to customers may be up to a few hours during which no contact lenses are produced in the manufacturing line that are later on distributed to customers. This negatively affects the efficiency of the manufacturing line. In addition, for maintaining top quality of the lenses during “actual” production it is necessary to take samples of lenses out of the “actual” production process at predetermined time intervals in order to make sure that the lenses manufactured during “actual” production have the desired specifications.

Therefore, it is an object of the invention to overcome the afore-mentioned disadvantages of the prior art and to suggest a method that greatly increases the efficiency of the manufacturing line during set-up, such as for example before starting a new production lot.

### SUMMARY

According to one aspect of the present invention, there is provided a method for automated inline determination of the refractive power of an ophthalmic lens in an automated manufacturing line for ophthalmic lenses, for example soft contact lenses. The method comprises the steps of:

providing an inspection cuvette comprising an optically transparent bottom having a concave inner surface and containing the ophthalmic lens immersed in a liquid, and positioning the inspection cuvette at a first inspection location of an inspection module of the automated manufacturing line;

providing a light source and a wavefront sensor, the wavefront sensor comprising a detector for receiving light coming from the light source and having passed the ophthalmic lens contained in the inspection cuvette and impinging on the detector, thus generating signals at the detector;

comparing the signals generated at the detector with predetermined signals representative of a reference refractive power thereby determining the refractive power of the ophthalmic lens.

Determination of the refractive power of the ophthalmic lens using a wavefront sensor is performed inline in the automatic manufacturing line while the ophthalmic lens is in the inspection cuvette. The term “refractive power” as used herein is to be understood in a very general sense, for instance as one or a combination of refractive properties of an ophthalmic lens, for example of a spherical or toric soft contact lens, such as for example the spherical refractive power of a spherical soft contact lens, the cylindrical power of a toric contact lens, the orientation of the cylinder axes, aberrations, etc.

Inline inspection of the ophthalmic lenses in the manufacturing line highly increases the efficiency of the manufacturing line, since it is no longer necessary to produce “dummy” contact lenses. Rather, the lenses previously produced as “dummy” lenses may be forwarded for packaging and distribution in case the result of the inline inspection is that the produced lenses fulfill the desired specifications. Thus, considerable time during which the manufacturing line does not produce lenses which are distributed to customers can be saved which was previously necessary to produce and offline inspect the “dummy” lenses. Also, the top quality standard of such a process is maintained or even improved, since the refractive power of each manufactured lens is individually determined inline in the manufacturing process.

The ophthalmic lens contained in the inspection cuvette has passed all manufacturing steps. Thus, the specifications of the inspected lens cannot be affected anymore by manufacturing and/or treatment steps after inline inspection of the lens since no such steps are performed after inline inspection. The ophthalmic lens may in particular be a soft contact lens, and may especially be a soft contact lens made of or comprising a silicon hydrogel material without being limited thereto. The process of manufacturing soft contact lenses typically is a highly automated mass manufacturing process. Therefore, performing the method according to the invention in a process of manufacturing soft contact lenses (such as single use contact lenses which are disposed of after use) is particularly effective, since the quality control for the produced contact lenses is improved.

After the lens is inserted into the liquid contained in the inspection cuvette, for example with the aid of a gripper, the lens floats downwardly in the liquid with the front surface of the lens facing towards the concave bottom. As soon as the lens has settled down, it is positioned with its convex front surface at the center of the concave inner surface which forms the lowermost location of the concave inner surface of the bottom of the inspection cuvette. An inspection cuvette suitable for use in the method according to the invention is described, for example, in WO 2007/017138.

Wavefront sensors per se are well-known in the art. For example, one type of wavefront sensor is that of the optical system available under the trademark WaveGauge® from the Company PhaseView, Palaiseau, France. These sensors compute the wavefront from the difference between two slightly defocused beam intensity images in two different planes. Alternatively, wavefront sensors comprising an array of micro-lenses can be used as well, e.g. Shack-Hartmann-Sensors. The detector receives light coming from a light source and having passed through the ophthalmic lens immersed in the liquid contained in the inspection cuvette and impinging on the detector, thus generating signals at the detector. These signals contain information about the refractive power of the ophthalmic lens. The signals generated at the detector are compared with predetermined signals representative of a known reference refractive power thereby determining the refractive power of the ophthalmic lens.

The reference refractive power may for example be a theoretical value of the refractive power of an ideal ophthalmic lens having a known refractive power, or may be the refractive power of an ideal optical system having a known refractive power. Alternatively, the reference refractive power may correspond to a previously determined refractive power of a real reference ophthalmic lens having a known refractive power, of an inspection cuvette having a known refractive power, or of another optical system having a known refractive power.

Optical systems for refractive power measurement using wavefront sensors are commercially available. For example, an optical system for refractive power measurement is available under the trademark WaveGauge® from the Company PhaseView, Palaiseau, France, as already mentioned above. Another optical system is known under the name “SHSOphthalmic” from the company Optocraft, Erlangen, Germany, which can be easily adapted to the inline measurement set-up of the invention. Both optical systems are well-known in the ophthalmic industry and allow the measurement of the refractive power of spherical as well as of toric soft contact lenses.

According to a further aspect of the method according to the invention, the step of providing a wavefront sensor comprises providing a wavefront sensor comprising an array of micro-lenses, for example a Shack-Hartmann-Sensor.

Using a wavefront sensor comprising an array of micro-lenses, for example a Shack-Hartmann-Sensor, is a particular manner of performing refractive power measurements. The set-up and working principle of Shack-Hartmann-Sensors are well-known to those skilled in the art and will therefore not be described in detail. Basically, in the Shack-Hartmann-Sensor a two-dimensional detector is arranged in the focal plane of a micro-lens array. At the positions of the focal spots of the individual micro-lenses of the micro-lens array on the detector corresponding signals are generated at the detector. Deviations of the actual positions of the focal spots from reference positions are representative of the slope of the wavefront of light incident on a particular focal spot on the sensor. This slope of the wavefront of light carries information about the refractive power of the inspected ophthalmic lens, since the slope of the wavefront is caused by the refractive power of the ophthalmic lens. By comparing the actual signals generated at the detector with predetermined signals representative of a reference refractive power the refractive power of the inspected ophthalmic lens can be determined.

According to a further aspect of the method according to the invention, the step of determining the refractive power of the ophthalmic lens comprises

providing the inspection cuvette comprising the optically transparent bottom and containing the liquid but not containing the ophthalmic lens at the first inspection location of the inspection module of the automated manufacturing line;

the wavefront sensor receiving light coming from the light source and having passed the optically transparent bottom of the inspection cuvette and the liquid and impinging on the detector of the wavefront sensor, and from the signals thus generated at the detector, determining the refractive power of the inspection cuvette containing the liquid but not containing the ophthalmic lens;

considering the refractive power of the inspection cuvette containing the liquid but not containing the ophthalmic lens when determining the refractive power of the ophthalmic lens.

The inspection cuvette comprising an optically transparent bottom having a concave inner surface and containing the liquid but not containing an ophthalmic lens represents an optical system having a refractive power. Determining the refractive power of the “empty” inspection cuvette (containing the liquid but not containing the lens) may be used in order to be able to eliminate its effect on the refractive power measurements of the ophthalmic lens. To do this, the inspection cuvette containing the liquid but not containing the ophthalmic lens is positioned in the first inspection location. Light coming from the light source and having passed the bottom of the inspection cuvette and the liquid is impinging on the detector. From signals thus generated at the detector the refractive power of the “empty” inspection cuvette (containing the liquid but not containing the ophthalmic lens) is determined.

The so determined refractive power of the “empty” inspection cuvette may be used for a zero-adjustment of the refractive power measurement set-up, i.e. any effect of the measurement set-up on the refractive power measurement of the ophthalmic lens, especially any influence of the inspection cuvette containing the liquid, may be eliminated from the measured signals before a refractive power of the ophthalmic lens is determined (zero-adjustment).

In general, a measurement of the refractive power of the “empty” inspection cuvette is performed only once, preferably during set-up of the manufacturing line. The values for the refractive power of the inspection cuvette containing the liquid but not containing the ophthalmic lens or in case a plurality of inspection cuvettes are used, the values for the refractive powers of each of the inspection cuvettes containing the liquid but not containing an ophthalmic lens, are stored in a central control unit. The stored values may be used for determination of the refractive power of any further ophthalmic lenses eventually inspected in the inspection cuvette or inspection cuvettes the refractive power of which has been determined beforehand.

Accordingly, one advantage of the zero-adjustment as described above is that by measuring the refractive power of the “empty” inspection cuvette and taking said refractive power of the “empty” inspection cuvette into account upon determination of the refractive power of the ophthalmic lens, any influence of the measurement set-up on the determined refractive power of the ophthalmic lens may be eliminated, since the refractive power of the “empty” inspection cuvette basically comprises any refractive power of any components of the measurement set-up where light for refractive power measurement passes through.

According to another aspect of the method according to the invention, the step of considering the refractive power of the inspection cuvette containing the liquid but not containing the ophthalmic lens when determining the refractive power of the ophthalmic lens comprises

providing the inspection cuvette containing the ophthalmic lens immersed in the liquid at the first inspection location of the inspection module of the automated manufacturing line;

generating at the detector of the wavefront sensor signals representative of the collective refractive power of the inspection cuvette containing the ophthalmic lens immersed in the liquid;

subtracting the refractive power of the inspection cuvette containing the liquid but not containing the ophthalmic lens from the collective refractive power of the inspection cuvette containing the ophthalmic lens, thus obtaining the refractive power of the ophthalmic lens.

If a refractive power measurement is performed on an inspection cuvette containing an ophthalmic lens immersed in the liquid, light coming from the light source passes through the bottom of the inspection cuvette, the liquid and the ophthalmic lens, and is then impinging on the detector. The signals so generated at the detector contain information not only of the refractive power of the ophthalmic lens but of a collective refractive power of the entire optical system ‘inspection cuvette-liquid-ophthalmic lens’. By subtracting the refractive power of the inspection cuvette containing the liquid which has been determined beforehand—from the collective refractive power of the entire optical system ‘inspection cuvette-liquid-ophthalmic lens’, the influence of the inspection cuvette containing the liquid on the refractive power of the ophthalmic lens may be eliminated.

It is to be understood that a zero-adjustment as described above is especially favorable in case the “empty” inspection cuvette or the inspection cuvettes have non-negligible or varying refractive powers. However, a zero-adjustment may not be required if the “empty” inspection cuvette or the “empty inspection cuvettes” have no or only a negligible refractive power. A zero-adjustment, either of the measurement set-up or of the determined refractive power, may also be achieved by simply subtracting a predetermined value for the refractive power of the “empty” inspection cuvette without actually measuring the refractive power of the “empty” inspection cuvette.

According to a further aspect of the method according to the invention, the method further comprises the steps of:

comparing the determined refractive power of the ophthalmic lens with a predetermined set refractive power of the ophthalmic lens; and

identifying the ophthalmic lens as having an unacceptable refractive power if the determined refractive power of the ophthalmic lens is outside a predetermined range of tolerance around the predetermined set refractive power of the ophthalmic lens, or

identifying the ophthalmic lens as having an acceptable refractive power if the determined refractive power is within the predetermined range of tolerance around the predetermined set refractive power of the ophthalmic lens; and

removing the defective ophthalmic lens from the manufacturing line in case the ophthalmic lens has been identified as having an unacceptable refractive power, but further processing the ophthalmic lens in the manufacturing line in case the ophthalmic lens has been identified as having an acceptable refractive power.

Once a lens has been identified as having an unacceptable refractive power such lens does not meet the quality standards and is removed from the manufacturing line. On the other hand all lenses identified as having an acceptable refractive power are allowed to be further processed in the manufacturing line. However, this does not automatically mean that these lenses are distributed to customers. Although these lenses may remain in the manufacturing line they may have bubbles, edge defects, inclusions or other defects. Accordingly, if these lenses are—during further inspection—identified as being defective, they may later on be removed from the manufacturing line.

An ophthalmic lens that has been identified as having an unacceptable refractive power does not have to be removed from the manufacturing line immediately after the inspection cuvette is moved away from the first inspection location. The lens can also be removed from the manufacturing line at a later stage, however, in any event before being placed in a package.

A predetermined set refractive power of the ophthalmic lens may in a specific case be a set refractive power which is stored in the central control unit of the manufacturing line and which is related to the mold the ophthalmic lens has been produced with. In general, in an automated manufacturing line, each manufactured lens is traced during the entire manufacturing process and any information regarding the lens, e.g. actual position in the manufacturing line or inspection results, is stored in a central control unit. In addition, the specifications of the molds in the manufacturing line for producing the ophthalmic lenses are stored in the central control unit as well. Therefore, to determine whether a lens is acceptable or unacceptable as regards its refractive power, the determined refractive power of the ophthalmic lens may directly be compared with the refractive power corresponding to the refractive power specification of the corresponding mold the lens has been produced with.

According to another aspect of the method according to the invention, the method comprises the steps of:

providing a plurality of inspection cuvettes each inspection cuvette comprising an optically transparent bottom having a concave inner surface and containing an ophthalmic lens immersed in a liquid and positioning the plurality of inspection cuvettes at the first inspection location of the inspection module;

sequentially determining the refractive power of each of the ophthalmic lenses contained in the plurality of inspection cuvettes.

The advantages of the method as such are the same as already described above and will not be described again. In addition, in an automated mass manufacturing process it is advantageous to perform the method for a plurality of lenses to enhance the efficiency (throughput) of the manufacturing line. In particular for a cyclic process, it is thus possible to inspect a plurality of lenses within one cycle of the process. Each inspection cuvette of the plurality of inspection cuvettes contains a lens immersed in the liquid. The plurality of inspection cuvettes is preferably arranged and held in a common inspection cuvette holder. The plurality of inspection cuvettes is moved into the first inspection location and after inspection of the ophthalmic lenses for refractive power the plurality of inspection cuvettes is moved out of the first inspection position to, for example, a second inspection location or to a packaging module.

A sequential determination of the refractive power of each of the plurality of ophthalmic lenses may be performed very quickly one after the other, for example using only one light source and only one wavefront sensor. As mentioned, in case of a cyclic process it is preferred that all determinations be performed within one process cycle.

According to a further aspect of the method according to the invention, the method further comprises the step of:

after determination of the refractive power of the ophthalmic lens or the ophthalmic lenses, moving the inspection cuvette containing the ophthalmic lens or the plurality of inspection cuvettes containing the ophthalmic lenses from the first inspection location to a second inspection location; and

at the second inspection location performing an inline optical inspection of the ophthalmic lens contained in the inspection cuvette or of the ophthalmic lenses contained in the inspection cuvettes for the presence of other deficiencies.

Such inspection of the lenses for other defects may be performed in a conventional manner, for example with the aid of a CCD camera, so that this is not further described in detail here.

It is to be noted, that at the time of determining the refractive power of the lens, the lens may be in an inverted state (turned inside out) or in a non-inverted (normal) state. For a lens having only a spherical refractive power this may not be relevant, however, for a toric lens it is very well relevant whether the inspected lens is in the inverted or in the non-inverted state (determination of the cylinder axes). In this respect, it may be possible that the optical inspection system comprising the wavefront sensor may comprise a separate camera with the aid of which it is determined whether the lens is in the inverted or non-inverted state. In case the lens is in the inverted state, this is directly taken into account as the refractive parameters of the lens are determined. Alternatively, in case the optical inspection system comprising the wavefront sensor does not comprise such camera or in case such camera is not used, the refractive parameters determined with the aid of the wavefront sensor can be stored in a data storage until the lens has been inspected at the (second) inspection station where the lens is inspected for other deficiencies (flaws, inclusions, etc.). Since this is done with the aid of a camera, it can also be determined at this (second) inspection station whether the lens is in the inverted or non-inverted state. Once the information whether the inspected lens is in the inverted or non-inverted state, the refractive parameters are determined and/or displayed.

Optionally, the method according to the invention may be designed in a manner such as to additionally allow for an inline determination of the center thickness of the ophthalmic lens. The inspection module of the automated manufacturing line is equipped accordingly as will be described further below.

Therefore, according to another aspect of the method according to the invention, the method comprises the steps of:

positioning the inspection cuvette at a third inspection location of the inspection module of the automated manufacturing line for determination of the center thickness of the ophthalmic lens;

providing an interferometer comprising a light source and a focusing probe, the focusing probe focusing light coming from the light source to a set position of the ophthalmic lens at the center of the concave inner surface of the optically transparent bottom of the inspection cuvette, and the focusing probe further directing light reflected at the boundary between the back surface of the ophthalmic lens and the liquid on the one hand as well as light reflected at the boundary between the front surface of the ophthalmic lens and the liquid or light reflected at the boundary between the front surface of the ophthalmic lens and the concave inner surface of the optically transparent bottom of the inspection cuvette on the other hand to a detector of the interferometer; and

determining the center thickness of the ophthalmic lens from the signals generated at the detector of the interferometer by the light reflected at the respective boundary at the back surface and at the front surface of the ophthalmic lens.

The terms “first inspection location”, “second inspection location” and “third inspection location” are not intended to be limited to a particular sequence, they are just intended to be able to distinguish between these inspection locations. Accordingly, by way of example in one embodiment the third inspection location may be situated before (upstream of) the first inspection location where the refractive power measurement is performed (that is to say ahead in view of the processing direction in the manufacturing line).

Interferometric determination of the center thickness of the ophthalmic lens is also performed inline in the automated manufacturing line while the ophthalmic lens is in the inspection cuvette. Determination of the center thickness is performed in the third inspection location, wherein the terms first, second and third inspection location are only used to distinguish the inspection locations from one another rather than defining a specific sequence in the manufacturing line. The various inspections may be performed before or after one another and basically independent from each other, and may especially be combined at will.

All advantages mentioned with respect to the inline determination of the refractive power also apply to the inline determination of the center thickness of ophthalmic lenses. In particular, no “dummy” lenses need to be produced and inspected offline thus saving considerable time during set-up of the manufacturing line. In addition, the top quality standard of the manufacturing process is improved, since the center thickness as well as the refractive power of each manufactured lens is individually determined inline.

Since the manufacturing of soft contact lenses is a highly automated mass manufacturing process, the advantages already described above are of particular significance: By performing inline inspection of refractive power as well as of center thickness, the automatization is further enhanced by improving the quality control regime for the produced contact lenses.

Interferometers are well-known in the art. The interferometer used in the method according to the instant invention comprises a light source emitting light of low coherence, and a focusing probe which focuses light coming from the light source to a set position of the lens at the center of the concave inner surface of the optically transparent bottom of the inspection cuvette. The focusing probe further directs light reflected at the boundary between the back surface of the lens and the liquid to a detector of the interferometer. The reflected light is directed to interfere with reference light at the detector, and the resulting interference pattern is used for the determination of the center thickness of the ophthalmic lens. Determination of the thicknesses of small objects using interferometers is well-known in the art and is therefore not described in more detail. Interferometers suitable for use in the method according to the invention are commercially available. For example, an interferometer available under the name “OptiGauge” from the company Lumetrics, Rochester, N.Y., USA, may be used.

According to another aspect of the method according to the invention, the step of determining the center thickness of the ophthalmic lens comprises:

in case the ophthalmic lens rests on the concave inner surface of the optically transparent bottom of the inspection cuvette, selecting the signal generated by the light reflected at the boundary between the front surface of the ophthalmic lens and the concave inner surface of the optically transparent bottom of the inspection cuvette as well as the signal generated by the light reflected at the boundary between the back surface of the ophthalmic lens and the liquid;

in case the ophthalmic lens is floating at a distance above the concave inner surface of the optically transparent bottom of the inspection cuvette, selecting the signal generated by the light reflected at the boundary between the front surface of the ophthalmic lens and the liquid as well as the signal generated by the light reflected at the boundary between the back surface of the ophthalmic lens and the liquid.

As already mentioned above, “selecting the signal generated by the light reflected at the boundary” stands for selecting a signal which is the result of interference at the detector of the light reflected at the respective boundary with a reference light. In the first measurement scenario mentioned above, the ophthalmic lens rests on the concave inner surface of the bottom of the inspection cuvette. In this scenario light is reflected at the boundary between the front surface of the ophthalmic lens and the concave inner surface of the bottom of the inspection cuvette, since the lens rests on the surface and there is no liquid between the front surface of the lens and the concave inner surface at the location where the lens rests on the concave inner surface. Consequently, there is no boundary between the front surface of the lens and the liquid at the location where the lens rests on the surface (which corresponds to the center of the lens). In the second measurement scenario mentioned above, the ophthalmic lens is floating at a short distance above the concave inner surface of the bottom of the inspection cuvette, that is to say the lens does not rest on the concave inner surface. In this measurement scenario, there is a boundary between the front surface of the lens and the liquid and, accordingly, light is reflected at the boundary between front surface of the lens and the liquid resulting in a corresponding signal being present at the detector. Therefore, while in a fully automated manufacturing line both scenarios may occur it is advantageous that the method according to the invention is generally capable of handling both scenarios. In both scenarios there is a boundary between the back surface of the lens and the liquid, so that a corresponding signal is present at the detector. This signal is used in both scenarios for determining the center thickness of the lens. A preferred manner of how the two scenarios can be dealt with will be explained in the following.

According to another aspect of the method according to the invention, the step of determining the center thickness of the ophthalmic lens comprises

counting a number of signals generated by the light reflected at the respective boundary; and

for a counted number of two signals, selecting the two signals for determining the center thickness of the ophthalmic lens,

for a counted number of three signals, ignoring the signal corresponding to the light reflected at the boundary between the concave inner surface of the optically transparent bottom of the inspection cuvette and the liquid, and selecting the remaining two signals for determining the center thickness of the ophthalmic lens.

This is one particular way how the afore-mentioned two scenarios can be handled. Regardless of whether the lens rests on the concave inner surface of the inspection cuvette or is floating at a distance above the inner concave surface, the counted number of signals is indicative of the respective scenario. In the scenario where the ophthalmic lens rests on the concave inner surface of the bottom of the inspection cuvette, only two signals will be present (there is no boundary between the inner concave surface of the bottom of the cuvette and the liquid and no boundary between the front surface of the lens and the liquid, since the lens rests on the inner concave surface). The center thickness of the ophthalmic lens is then determined from the two signals generated by the light reflected from the boundary between the front surface of the lens and the inner concave surface of the inspection cuvette on one hand, and by the light reflected at the boundary between the back surface of the lens and the liquid. In the scenario where the ophthalmic lens is floating at a short distance above the concave inner surface of the bottom of the inspection cuvette, a signal is generated by light reflected at the boundary between the concave inner surface of the bottom of the inspection cuvette and the liquid (the lens does not rest on the inner concave surface). In this scenario, this signal is irrelevant for determining the center thickness of the ophthalmic lens and is ignored. The remaining two signals generated by the light reflected at the boundary between the front surface of the lens and the liquid and at the boundary between the back surface of the lens and the liquid are selected for determining the center thickness of the lens.

According to a further aspect of the method according to the invention, the method further comprises the steps of:

comparing the determined center thickness of the ophthalmic lens with a predetermined set value for the center thickness; and

identifying the ophthalmic lens as having an unacceptable center thickness if the determined center thickness is outside a predetermined range of tolerance around the predetermined set value for the center thickness, or

identifying the ophthalmic lens as having an acceptable center thickness if the determined center thickness is within the predetermined range of tolerance around the predetermined set value for the center thickness; and

removing the ophthalmic lens from the manufacturing line in case the ophthalmic lens has been identified as having an unacceptable center thickness, but further processing the ophthalmic lens in the manufacturing line in case the ophthalmic lens has been identified as having an acceptable center thickness.

The handling and further processing of an ophthalmic lens that has been identified as having an acceptable or unacceptable center thickness is preferably the same as for ophthalmic lenses having an acceptable or an unacceptable refractive power. This has already been described above in detail and is not repeated here again.

The range of tolerance may be chosen symmetrically around the predetermined set value for the center thickness. However, the range of tolerance may also be non-symmetrical around the set value for the center thickness for various reasons. For example, lenses having too low a center thickness may turn out to be fragile, while especially for lenses having negative diopters too high a center thickness would lead to too thick a lens edge that reduces the wearing comfort of the lens.

According to another aspect of the method according to the invention, the method comprises the steps of:

providing the plurality of inspection cuvettes at the third inspection location of the inspection module;

providing a plurality of focusing probes corresponding to the plurality of inspection cuvettes, each of the focusing probes focusing light to a set position of the ophthalmic lens at the center of the concave inner surface of the optically transparent bottom of a corresponding inspection cuvette, and each of the focusing probes directing light reflected at the respective boundary at the back surface and at the front surface of the respective ophthalmic lens to the receiving unit of the interferometer; and

determining the center thickness of each of the ophthalmic lenses.

The advantages of the method performed for a plurality of lenses together, as well as of the method including determining the center thickness of an ophthalmic lens as such are the same as already described above. In a fully automated manufacturing line where the method is performed for a plurality of lenses in one cycle, these individual advantages add up to provide a manufacturing process for ophthalmic lenses that is particularly time saving and that further enhances the quality control of the manufactured lenses.

From a practical point of view, a number of focusing probes is assigned to a corresponding number of inspection cuvettes for performing interferometric measurements on a plurality of lenses. Each inspection cuvette of the plurality of inspection cuvettes contains a lens immersed in the liquid. The plurality of inspection cuvettes is preferably arranged and held in a common inspection cuvette holder. The plurality of focusing probes is fixedly arranged at the third inspection location, and the plurality of cuvettes is moved into the third inspection location. Only one interferometer including light source, detector, processing unit etc. is required for the plurality of interferometer probes and inspection cuvettes, as will be explained in more detail below. This is advantageous since an interferometer is an expensive component.

In one aspect of the method according to the invention, focusing light to a set position of the ophthalmic lens is performed sequentially for the plurality of inspection cuvettes. This is performed by directing light from the light source of the interferometer via a first focusing probe of the plurality of focusing probes to the set position of the ophthalmic lens in a first inspection cuvette of the plurality of inspection cuvettes. Subsequently light is directed from the light source of the interferometer via a second focusing probe to the set position of the ophthalmic lens in a second inspection cuvette and so on, until light from the light source of the interferometer is directed via a last focusing probe of the plurality of focusing probes to the set position of the ophthalmic lens in a last inspection cuvette of the plurality of inspection cuvettes.

By sequentially directing light onto the set position of the ophthalmic lens at a concave inner surface of the bottom of the inspection cuvette, interferometric determination of the thickness of each of the plurality of ophthalmic lenses may be performed very quickly one after the other using only one single interferometer. In case of a cyclic process, it is preferred that all determinations be performed within one process cycle.

In a further aspect of the method according to the invention the step of sequentially focusing light to a set position of the ophthalmic lens for the plurality of inspection cuvettes comprises

providing a plurality of deflectors corresponding to the plurality of focusing probes, the individual deflectors of the plurality of deflectors each being capable of being switched between an active state, in which the respective deflector directs light coming from the light source of the interferometer to the corresponding focusing probe and in which the respective deflector directs light reflected at the respective boundary surface to the detector of the interferometer, and a passive state, in which the respective deflector allows the light coming from the light source to pass to the next deflector which is in the active state and which is arranged in an optical path of the light; and

sequentially switching a first deflector of the plurality of deflectors from the active state to the passive state after determining the center thickness of the ophthalmic lens contained in the first inspection cuvette, switching a second deflector of the plurality of deflectors from the active state to the passive state after determining the center thickness of the ophthalmic lens contained in the second inspection cuvette, and so on, until switching a second last deflector of the plurality of deflectors from the active state to the passive state after determining of the center thickness of the ophthalmic lens contained in the second last cuvette, and then determining the center thickness of the ophthalmic lens contained in the last inspection cuvette with the last deflector being in the active state.

In this variant, light from the light source of the interferometer is sequentially directed by the individual deflectors to the respective focusing probes, and light reflected at the respective boundary is directed to the detector of the interferometer as long as the deflector is in the active state. After being switched from the active to the passive state upon completion of the determination of the center thickness of the lens contained in the respective inspection cuvette, the center thickness of the lens contained in the “next inspection cuvette in the queue” is determined in the same manner with the respective deflector being in the active state, until the center thickness of the lens contained in the last inspection cuvette in the queue has been determined. It goes without saying, that it is also possible to start determination of the lens thickness for the lens contained in the “last inspection cuvette in the queue” with all preceding deflectors being deactivated, i.e. in the passive state, and with only the last deflector being in the active state, and then proceeding switching the second last deflector to the active state, etc., until the deflector of the first inspection cuvette in the queue has been switched to the active state and the center thickness of the first lens has been determined.

The deflectors may be embodied as small mirrors which can be rapidly switched mechanically from an active state to a passive state, or may alternatively be mirrors the transparency of which can be electronically activated or deactivated. For example, in case of mirrors which can be mechanically switched the mirrors can be tilted about an axis to be either in the active state or in the passive state. In case of electronically switchable mirrors, the transparency of the respective mirrors can be switched with the aid of a control voltage or a control current, as this is conventional in the art.

Switching can be performed with the aid of a commercially available multi-switch, such as for example the multi-switch LightBend™ Fiberoptic of the Type LBMN183111300 manufactured and distributed by the company Agiltron, Inc, Woburn, Mass., 01801, United States of America. This switching can be performed at a location remote from the location of the cuvettes and the light can be transported via optical fibers to the respective focusing probes. This is advantageous since it may be desirable to place the interferometer and other sensitive equipment at a location remote from the manufacturing line.

In accordance with a further aspect of the method according to the invention, the method further comprises the step of individually adjusting each focusing probe of the plurality of focusing probes so as to focus light coming from the light source of the interferometer to the corresponding set position of the concave inner surface of the optically transparent bottom of the respective inspection cuvette of the plurality of inspection cuvettes. This allows to fixedly install the focusing probes at the third inspection location and to individually adjust them to achieve optimum determination of the center thickness. This must be done only once at the set-up of the manufacturing line, since the inspection cuvettes always arrive at the third inspection location at the same position relative to the fixedly installed focusing probes, so that once the focusing probes are individually adjusted for optimum center thickness determination no readjustment is need. This is all the more the case since the adjustment of the focus of the respective focusing probe is not that critical.

A separate adjustment of each of the focusing probes allows a very precise and individual adjustment of a focusing probe relative to the inspection cuvette, for example in an inspection cuvette holder. Thereby, the focusing onto the set position of the ophthalmic lens at the center of the concave inner surface of the optically transparent bottom of each inspection cuvette is defined and adjusted very precisely. For an individual adjustment preferably the focusing probe is moved relative to the inspection cuvette and on a common translation axis.

According to another aspect of the present invention, there is provided an automated manufacturing line for manufacturing ophthalmic lenses, for example soft contact lenses. The manufacturing line comprises a production module for manufacturing ophthalmic lenses and an inspection module for inspecting the manufactured ophthalmic lenses. The inspection module comprises a wavefront sensor comprising an array of micro-lenses and a detector. The wavefront sensor is arranged at a first inspection location and is capable of receiving light from a light source, for inspection of ophthalmic lenses being contained in a plurality of inspection cuvettes. Each inspection cuvette comprises an optically transparent bottom and contains the ophthalmic lens immersed in a liquid. In operation the inspection module performs the method according to the invention.

According to another aspect of the present invention, in the automated manufacturing line the inspection module further comprises an interferometer and a plurality of focusing probes. The plurality of focusing probes are arranged at a third inspection location and are capable of being optically connected to the interferometer, for inspection of ophthalmic lenses being contained in a plurality of inspection cuvettes corresponding to the plurality of focusing probes. Each inspection cuvette comprises an optically transparent bottom having a concave inner surface and contains the ophthalmic lens immersed in a liquid. In operation the inspection module performs the method according to the invention, which method optionally also allows for an inline determination of the center thickness of an ophthalmic lens.

The advantages of the automated manufacturing line for performing inline determination of the refractive power and optionally also of the center thickness of an ophthalmic lens have been described above with reference to the method according to the present invention and will therefore not be described again.

### BRIEF DESCRIPTION OF THE DRAWINGS

In the following embodiments of the method and the manufacturing line according to the invention are described in more detail with reference to the accompanying drawings, wherein

FIG. 1 shows a perspective top view of an inspection module of an automated manufacturing line for ophthalmic lenses including a plurality of inspection cuvettes, in accordance with one embodiment of the invention;

FIG. 2 shows the working principle of a Shack-Hartmann-Sensor;

FIG. 3 shows a measurement set-up for the method for automated inline determination of the refractive power of an ophthalmic lens arranged on the concave bottom of an inspection cuvette, in accordance with an embodiment of the invention;

FIG. 4 shows a side view of a plurality of focusing probes of an interferometer and a corresponding plurality of inspection cuvettes, for determining the center thicknesses of the respective ophthalmic lenses contained in the respective cuvettes, in accordance with a further embodiment of the invention;

FIG. 5 shows a cross section through one of the cuvettes of FIG. 4;

FIGS. 6-8 show different measurement scenarios, namely a cuvette bottom only (FIG. 6), an ophthalmic lens floating above the concave inner surface of the cuvette bottom (FIG. 7), and an ophthalmic lens resting on the concave inner surface of the cuvette bottom (FIG. 8); and

FIG. 9 shows a multi-switch directing light from the interferometer to the individual focusing probes.

### FURTHER DESCRIPTION OF EMBODIMENTS

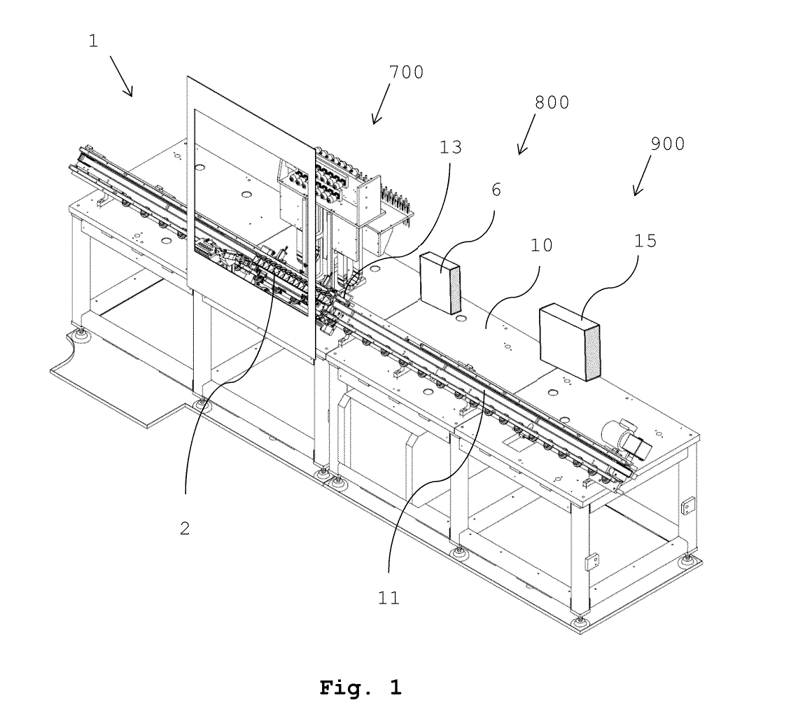

In FIG. 1 an inspection module 1 (which may for example be part of an automated manufacturing line for ophthalmic lenses, preferably soft contact lenses) is shown. A rack 10 has a linear conveyor 11 arranged thereon for moving a plurality of inspection cuvettes 2 mounted to a carrier 13 along the rack 10. In FIG. 1, the inspection cuvettes 2 mounted to carrier 13 are arranged in an inspection location 700 (“third inspection location”) and may be moved with the aid of the conveyor 11 to another inspection location 800 (“first inspection location”), where refractive power measurement is performed. At inspection location 800 a wavefront sensor 6 is arranged above the conveyor 11 such that refractive power measurement on the plurality of inspection cuvettes 2 can be performed when the inspection cuvettes 2 are in the inspection location 800. A light source also required for performing the refractive power measurement is preferably arranged below carrier 13 or even below the rack 10. Light from the light source is directed through corresponding openings in the rack 10 and/or in the carrier 13, respectively, and through the inspection cuvette 2 as well as through the lens contained therein immersed in a liquid to the wavefront sensor 6. Of course, it is also possible to arrange the light source above conveyor 11 (above the inspection cuvettes 2) and to arrange wavefront sensor 6 below conveyor 11 (below the inspection cuvettes 2).

After refractive power measurement has been performed, carrier 13 and together with it the plurality of inspection cuvettes 2 are moved by linear conveyor 11 from inspection location 800 to a further inspection location 900 (“second inspection location”). At inspection location 900 an optical inspection device 15, such as for example a camera, is arranged for performing a commonly known optical inspection of the lens for further deficiencies. Such further deficiencies are for example edge defects, inclusions, bubbles, fissures or flaws, without this list being exhaustive. Once optical inspection for further deficiencies has been completed, the plurality of inspection cuvettes 2 may automatically be further transported to a packaging module (not shown), where the ophthalmic lenses are removed from the inspection cuvettes and placed into their packaging, for example with the aid of grippers.

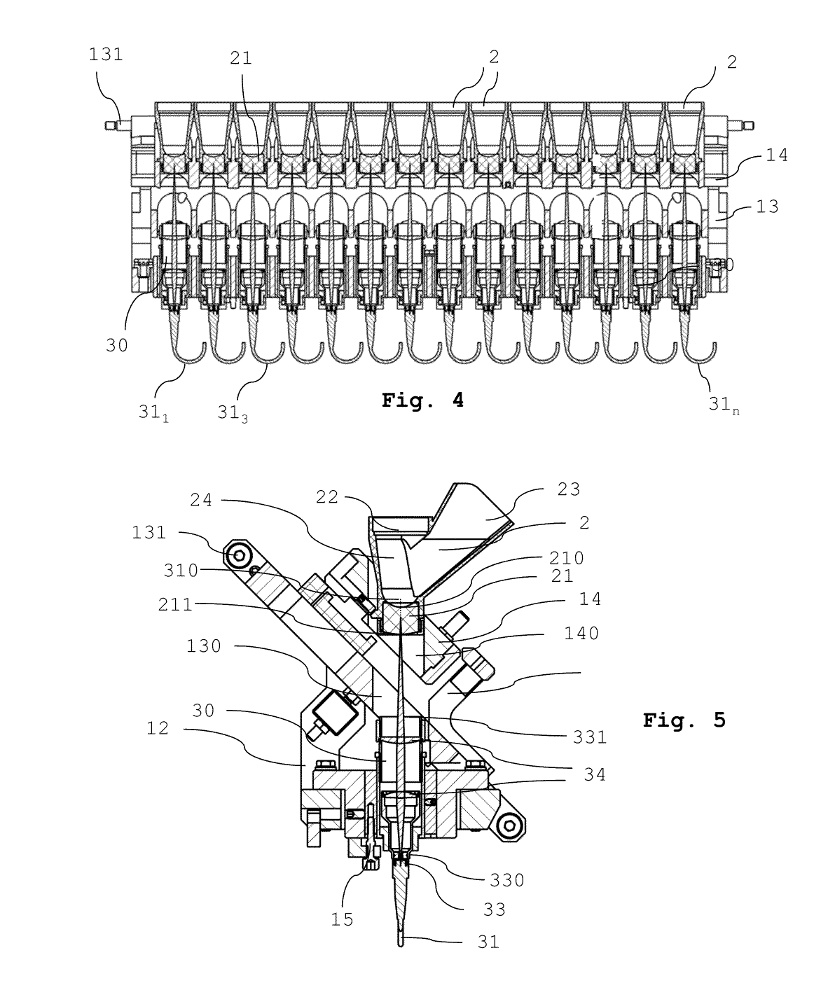

Optionally, at inspection location 700 the center thickness of the ophthalmic lenses may be determined through an interferometric measurement. Parts of the interferometric measurement equipment are arranged below the inspection cuvettes (not shown in FIG. 1, see FIG. 4). The interferometer is preferably arranged at a location remote from rack 10 in order to minimize the influence of any vibrations on the interferometric measurement. Details of the interferometric measurement will be described further below. The sequence of the inspections performed at the different inspection locations 700, 800, 900 is not limited to the sequence shown in FIG. 1 but may be changed.

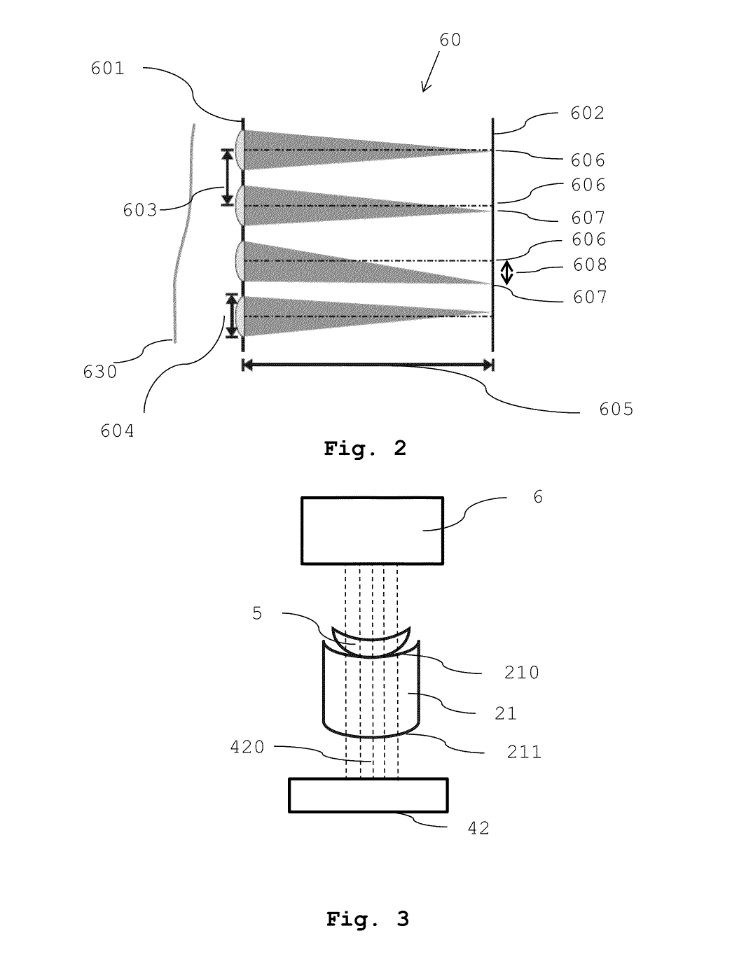

FIG. 2 shows the general configuration and working principle of a Shack-Hartmann-Sensor 60. The Shack-Hartmann-Sensor 60 comprises a two-dimensional array of micro-lenses 601 which are spaced at a distance 603 from one another and have the same diameter 604 and focal length 605. The sensor 60 further comprises a two-dimensional optical detector 602, for example a CMOS chip, a chip of a CCD camera or another position sensitive detector arranged in the focal plane of the micro-lens array 601. An ideal plane wavefront incident normal to the micro-lens array 601 would produce a regular array of focal spots 606 on the detector. However, a real wavefront 630 deviating from an ideal plane wavefront (see FIG. 1) produces an array of focal spots 607 which are spatially displaced relative to the focal spots 606 which would be generated by an ideal plane or even wavefront. This spatial displacement is indicated by double arrow 608. The local slope or tilt of the wavefront 630 incident on each micro-lens results in the displacement of the respective actual focal spot 607 from the ideal focal spot 606. Thus, the spatial displacement 608 of the actual focal spot 607 from the ideal focal spot 606 carries information of the local slope or tilt of the wavefront incident on the respective micro-lens. The refractive power of an inspected ophthalmic lens can then be determined, for example, by comparing the spatial displacements 608 of the actual focal spots 607 (caused by the inspected ophthalmic lens) with known displacements caused by a lens having a predetermined refractive power.

Generally and as already mentioned above, the refractive power of the lens may be a combination or a superposition of individual refractive properties of the lens which together define the (total) refractive power of the lens. By way of example, in the case of a spherical lens the refractive power is defined by only one single refractive power, commonly expressed in diopters (dpt). The refractive power of toric lenses is typically defined by defined by the cylindrical power and the orientation of the cylinder axes.

As already mentioned above, Shack-Hartmann-Sensors and their use are generally known by those skilled in the art and therefore, they are not described in more detail here. As already mentioned above, Shack-Hartmann-Sensors comprise a two-dimensional micro-lens array and a two-dimensional detector arranged in the focal plane of the micro-lens array. Each micro-lens of the array generates a spot in the focal plane which may deviate from a reference position, depending on the local slope of the wavefront at the respective micro-lens. The actual position of the focal spot is detected and compared with the reference position. This can be performed with the aid of position-sensitive detectors, e.g. with a CCD camera chip. Also, optical systems for refractive power measurement using wavefront sensors (either Shack-Hartmann-Sensors or other types of wavefront sensors) are commercially available (see above). Such systems may be adapted to the measurement set-up according to the invention, an example of which is described in FIG. 3.

In FIG. 3 a measurement set-up for determining the refractive power of an ophthalmic lens 5 (immersed in liquid, not shown) contained in an inspection cuvette and using a wavefront sensor 6, preferably a Shack-Hartmann-Sensor 60, is schematically shown. A light source 42 is arranged to direct light 420 through the transparent bottom 21 of the inspection cuvette and the lens 5 immersed in the liquid, preferably water. The ophthalmic lens 5 rests on the concave inner surface 210 of the bottom 21 of the inspection cuvette. The light having passed the lens 5 and carrying information on the refractive power of the lens travels further to the wavefront sensor 6. In the wavefront sensor 6 (or in an analyzing unit coupled thereto or integrated therewith) the refractive power of the lens is determined by evaluating the signals generated at the individual pixels of the wavefront sensor 6.

The bottom 21 of the inspection cuvette with its concave inner surface 210 and convex outer surface 211 and the liquid contained in the cuvette constitute a kind of an optical system which has a refractive power independent from the refractive power of the lens 5 to be inspected (this optical system is not to be mixed up with the optical inspection system). Therefore, the determined total refractive power determined with the optical inspection system corresponds to the collective refractive power of the entire system ‘cuvette-liquid-lens’. In order to eliminate the influence of the cuvette containing the liquid a zero-adjustment measurement determining the refractive power of the inspection cuvette 2 containing the liquid but not containing the lens 5, i.e. of the “empty” inspection cuvette, may be performed. The zero-adjustment measurement can be performed once for each single cuvette of the manufacturing unit and can be stored in a data storage, so that the refractive power of the respective cuvette can later on be subtracted from the entire system ‘cuvette-liquid-lens’ to determine the refractive power of the lens 5 only.

In accordance with one aspect of the invention the measurement set-up comprises a plurality of inspection cuvettes 2 each comprising a lens 5, and this plurality of inspection cuvettes is positioned at inspection location 800, so that a plurality of lenses can be measured while they are positioned at inspection location 800. In particular in a cyclic manufacturing process (including the inspection), it is thus possible to determine the refractive power of a corresponding plurality of lenses within one cycle. For that purpose, the wavefront sensor 6 may be moved along the plurality of inspection cuvettes for receiving light having passed through the inspection cuvettes containing the lenses immersed in the liquid.

FIG. 4 shows an inspection measurement set-up for additional determination of the center thickness of the ophthalmic lens 5. A plurality of inspection cuvettes 2 are mounted to carrier 13 (already shown schematically in FIG. 1) via an inspection cuvette holder 14 (see also FIG. 5). A plurality of focusing probes 30 is arranged below the respective inspection cuvettes 2. The number of focusing probes 30 corresponds to the number of inspection cuvettes 2.

A cross sectional view of an inspection cuvette 2 arranged above a focusing probe 30 is shown in FIG. 5. The inspection cuvette 2 is arranged in the inspection position, that is to say a channel 23 of the inspection cuvette 2 for introduction of a gripper to insert and remove a lens is tilted relative to the vertical axis. For engagement with a tilting mechanism the carrier is provided with pins 131 on each side of the carrier 13. Bottom 21 of the inspection cuvette 2 and a viewing glass 22 of the inspection cuvette 2 forming an inspection channel 24 are arranged on a vertical axis. Bottom 21 of the inspection cuvette is transparent and has a concave inner surface 210 to receive an ophthalmic lens (not shown in FIG. 5) with its front surface to rest on concave inner surface 210. The outer surface 211 of transparent bottom 21 has a convex shape. Light for an interferometric measurement is incident from below the inspection cuvette 2 and passes through the transparent bottom 21 of the inspection cuvette 2.

The carrier 13 is arranged on a support 12 which is mounted to rack 10. Also the focusing probes 30 are mounted to rack 10 and support 12 such that a relative position of an inspection cuvette 2 and a corresponding focusing probe 30 is well-defined. The focusing probes 30 are mounted in a vertically adjustable manner, for example on a height adjustable mount 15 provided with a drive, such that through a vertical movement of the focusing probe 30 light may precisely be focused onto a set position 310 of an ophthalmic lens at the center of the concave inner surface 210 of the bottom 21 of the inspection cuvette 2. Thus, variations of the vertical distances between focusing probe 30 and inspection cuvette 2 may be compensated.

The focusing probes 30 at their lower ends 330 are provided with a coupling 33 for an optical fiber 31. The focusing probes are optically connected via these optical fibers 31 to an interferometer, such that light from the light source of the interferometer may be directed to the focusing probes 30 and also directed back from the focusing probes 30 to a receiving unit in the interferometer for performing the interferometric measurement and the determination of the center thicknesses of the ophthalmic lenses contained in the inspection cuvettes 2.

As can be seen in FIG. 5, light entering the focusing probe 30 at the lower end 330 is directed through an optical system 34 of the focusing probe 30 out of the upper end 331 of the focusing probe 30 and through openings 130, 140 in the carrier 13 and in the inspection cuvette holder 14. The light further passes through the transparent bottom 21 of the inspection cuvette 2 and is focused onto the set position 310 of the lens at the center of the concave bottom 21 of the inspection cuvette 2.

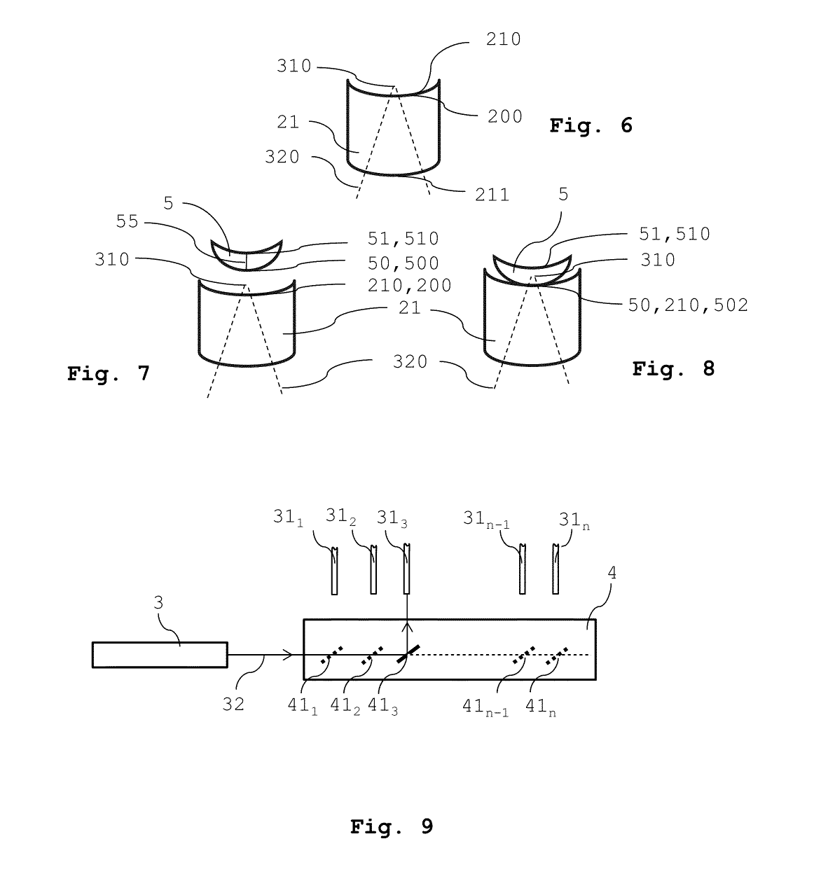

In FIGS. 6 to 8 details of the interferometric measurement are schematically illustrated for different measurement scenarios. FIG. 6 shows the bottom 21 of the inspection cuvette with concave inner surface 210 and convex outer surface 211. A lens 5 inserted into the liquid (e.g. water), contained in the inspection cuvette 2, floats downwards with its front surface 50 turned downwardly (FIG. 7). The shape of the concave inner surface 210 of the bottom 21 of the inspection cuvette 2 matches to some extent with the shape of the convex front surface 50 of the lens 5 in order to provide contact between lens 5 and bottom 21 when the lens rests on the inner surface 210 of the bottom 21 of the inspection cuvette (FIG. 8).

Light from below is directed through the bottom 21 and is focused to the set position 310 of the lens at the center of the bottom of the inspection cuvette 2. The light focused to the set position 310 is schematically indicated by dashed lines 320. Set position 310 essentially corresponds to a distance above the concave inner surface 210 of the bottom of the inspection cuvette 2 corresponding to half an average center thickness 55 of a lens when in contact with the concave inner surface 210 of the bottom 21 of the inspection cuvette 2 (see FIG. 8). Alternatively, the set position 310 may coincide with the center of the concave inner surface 210 of the bottom 21 of the inspection cuvette or with the center of the back surface 51 of the lens 5.

In FIG. 6 focused light is reflected only at the boundary 200 between the concave inner surface 210 of the bottom 21 of the inspection cuvette 2 and the liquid contained in the inspection cuvette. This reflected focused light is directed back through the focusing probe 30 to the receiving unit of the interferometer. The convex outer surface 211 of the bottom 21 of the inspection cuvette generally does not provide a sufficient signal due to the outer surface 211 being arranged too far out of focus.

In FIGS. 7 and 8 two measurement scenarios are shown that might occur during automated inspection of the lenses in the inspection cuvettes 2. In FIG. 7 the lens 5 has not settled onto the concave inner surface 210 of the bottom 21 of the inspection cuvette but is floating a short distance above the concave inner surface 210. Therefore, light focused to the set position 310 is reflected back from the boundary 200 between the concave inner surface 210 of the bottom 21 of the inspection cuvette 2 and the liquid (see also FIG. 6).

Light is also reflected back from the boundaries 500, 510 of the front surface 50 and back surface 51 of the lens 5. All three reflected light signals are within the depth of focus of the focused light and are directed back through the optical system 34 of the focusing probe 30 to the receiving unit of the interferometer. In the interferometer the two reflected signals from the boundaries 500, 510 of the front surface 50 and back surface 51 of the lens 5 are superimposed to a reference signal to form an interference pattern which is then used to determine the center thickness 55 of the lens 5. The signal caused by the focused light reflected from the boundary 200 between the concave inner surface 210 of the bottom 21 of the inspection cuvette and the liquid is ignored. That is to say, in the measurement situation shown in FIG. 7 three reflection signals are received, however, the first one—that one corresponding to light reflected at the boundary of the concave inner surface 210 of the bottom 21 of the inspection cuvette 2 and the liquid—is ignored since it does not contain information that is useful for the determination of the center thickness of the lens.

As already mentioned above, the light is focused by the focusing probes 30 such that it has a depth of focus spanning a range of several millimeters, so that focused light is also reflected at the boundaries 500,510 of the front surface 50 and back surface 51 of the lens floating at a small distance above the concave inner surface 210 of the bottom 21 of the inspection cuvette 2.

In FIG. 8 a measurement scenario is shown, where the lens 5 rests on the concave inner surface 210 of the bottom 21 of the inspection cuvette. Focused light is reflected from the boundary 510 between back surface 51 of the ophthalmic lens 5 and the liquid and from the boundary 502 between concave inner surface 210 of the bottom of the inspection cuvette and front surface 50 of the lens 5. In the measurement situation as shown in FIG. 8, only two reflected light signals are generated, which both carry information useful for the determination of the thickness of the lens 5. These two reflected light signals are directed back to the interferometer for the determination of the center thickness of the ophthalmic lens 5.

FIG. 9 shows a multi-switch 4 for directing light coming from the interferometer 3 to a plurality n of focusing probes (see FIG. 4) and for directing reflected light coming from the focusing probes back to the detector of the interferometer 3. The interferometer 3 is optically connected to each of the focusing probes (see FIG. 4) via a plurality n of optical fibers 311, 312, 313, . . . , 31n-1, 31n which are coupled to the plurality n of focusing probes 30. The multi-switch 4 comprises a plurality n of deflectors such as the mirrors 411, 412, 413, . . . , 41n-1, 41n and is arranged between interferometer 3 and the plurality n of optical fibers. The mirrors 411, 412, 413, . . . , 41n-1, 41n of the multi-switch 4 are arranged in an optical path 32 formed by the light coming from the light source in the interferometer 3. Light reflected at the boundaries 500,510 between lens 5 and the liquid contained in the inspection cuvette or light reflected at the boundary 502 between lens 5 and concave inner surface, and if applicable, also light reflected at the boundary 200 between concave inner surface 210 and the liquid contained in the inspection cuvette (see FIGS. 6 and 7), travels back along optical path 32 towards the detector of the interferometer. Each one of the mirrors 411, 412, 413, . . . , 41n-1, 41n is assigned to a respective optical fiber 311, 312, 313, . . . , 31n-1, 31n. The mirrors may be switched from a passive state in which they allow light coming from the light source of the interferometer 3 to pass to the next mirror in the active state, in which the respective mirror directs light coming from the light source of the interferometer 3 into the respective optical fiber 311, 312, 313, . . . , 31n-1, 31n, and vice versa.

In FIG. 9, the interferometric measurements using mirrors 411 and 412 have already been completed. The third mirror 413 of the plurality of n mirrors is in the active state directing light from the interferometer 3 into the third optical fiber 313. The remaining mirrors 411, 412, 414 to 41n of the multi-switch 4 are in the passive state, although it is also possible that only those mirrors which are arranged upstream of the first mirror 413 in the active state—viewed in the direction of the light coming from the light source of the interferometer 3 (that is to say mirrors 411 and 412)—are in the passive state while those mirrors which are arranged downstream of the first mirror 413 in the active state (that is to say mirrors 414 to 41n) may also be in the active state. Once the interferometric measurement has been completed with mirror 413 in the active state, third mirror 413 is switched to the passive state (deactivated). The same interferometric measurement is then repeated with fourth mirror 414 being in the active state, and so on, until the interferometric measurement is performed with the last mirror 41n.

By sequentially activating and deactivating the mirrors, interferometric measurement and determination of the center thicknesses of all lenses 5 contained in the plurality of inspection cuvettes is performed. Upon completion of all interferometric measurements, the plurality of inspection cuvettes can be moved from the other inspection location 800 in the inspection module 1, for example to a further inspection location 900.

In case mechanically operated mirrors are used, an activation and deactivation of mirrors corresponds to a tilting of a mirror into the optical path 32 and tilting the mirror out of the optical path.

While embodiments of the invention have been described with the aid of the drawings, various changes, modifications, and alternatives are conceivable without departing from the teaching underlying the invention. Therefore, the invention is not limited to the embodiments described but rather is defined by the scope of the appended claims.

1. A method for automated inline determination of the refractive power of an ophthalmic lens (5) in an automated manufacturing line for ophthalmic lenses, the method comprising the steps of:
providing an inspection cuvette (2) comprising an optically transparent bottom (21) having a concave inner surface (210) and containing the ophthalmic lens (5) immersed in a liquid, and positioning the inspection cuvette at a first inspection location (800) of an inspection module (1) of the automated manufacturing line;
providing a light source (42) and a wavefront sensor (6), the wavefront sensor (6) comprising a detector (602) for receiving light coming from the light source (42) and having passed the ophthalmic lens (5) contained in the inspection cuvette (2) and impinging on the detector (602), thus generating signals at the detector;
comparing the signals generated at the detector (602) with predetermined signals representative of a reference refractive power thereby determining the refractive power of the ophthalmic lens (5).

2. The method according to claim 1, wherein the step of providing a wavefront sensor (6) comprises providing a wavefront sensor comprising an array of micro-lenses (501).

3. The method according to claim 2, wherein the wavefront sensor comprising an array of micro-lenses (501) is a Shack-Hartmann-sensor (60).

4. The method according to claim 2, wherein the step of determining the refractive power of the ophthalmic lens (5) comprises
providing the inspection cuvette (2) comprising the optically transparent bottom (21) and containing the liquid but not containing the ophthalmic lens (5) at the first inspection location (800) of the inspection module (1) of the automated manufacturing line;
the wavefront sensor (6) receiving light coming from the light source (42) and having passed the optically transparent bottom (21) of the inspection cuvette (2) and the liquid and impinging on the detector (602), and from the signals thus generated at the detector (602) determining the refractive power of the inspection cuvette (2) containing the liquid but not containing the ophthalmic lens;
considering the refractive power of the inspection cuvette containing the liquid but not containing the ophthalmic lens when determining the refractive power of the ophthalmic lens.

5. The method according to claim 4, wherein the step of considering the refractive power of the inspection cuvette containing the liquid but not containing the ophthalmic lens when determining the refractive power of the ophthalmic lens comprises
providing the inspection cuvette (2) containing the ophthalmic lens (5) immersed in the liquid at the first inspection location (800) of the inspection module (1) of the automated manufacturing line;
generating at the detector (602) of the wavefront sensor (6) signals representative of the collective refractive power of the inspection cuvette (2) containing the ophthalmic lens (5) immersed in the liquid;
subtracting the refractive power of the inspection cuvette (2) containing the liquid but not containing the ophthalmic lens from the collective refractive power of the inspection cuvette (2) containing the ophthalmic lens, thus obtaining the refractive power of the ophthalmic lens (5).

6. The method according to claim 1, further comprising the steps of:
comparing the determined refractive power of the ophthalmic lens (5) with a predetermined set refractive power of the ophthalmic lens (5); and
identifying the ophthalmic lens (5) as having an unacceptable refractive power if the determined refractive power of the ophthalmic lens (5) is outside a predetermined range of tolerance around the predetermined set refractive power of the ophthalmic lens (5), or
identifying the ophthalmic lens (5) as having an acceptable refractive power if the determined refractive power of the ophthalmic lens (5) is within the predetermined range of tolerance around the predetermined set refractive power of the ophthalmic lens (5); and
removing the ophthalmic lens (5) from the manufacturing line in case the ophthalmic lens (5) has been identified as having an unacceptable refractive power, but further processing the ophthalmic lens (5) in the manufacturing line in case the ophthalmic lens (5) has been identified as having an acceptable refractive power.

7. The method according to claim 5, further comprising the steps of:
comparing the determined refractive power of the ophthalmic lens (5) with a predetermined set refractive power of the ophthalmic lens (5); and
identifying the ophthalmic lens (5) as having an unacceptable refractive power if the determined refractive power of the ophthalmic lens (5) is outside a predetermined range of tolerance around the predetermined set refractive power of the ophthalmic lens (5), or
identifying the ophthalmic lens (5) as having an acceptable refractive power if the determined refractive power of the ophthalmic lens (5) is within the predetermined range of tolerance around the predetermined set refractive power of the ophthalmic lens (5); and
removing the ophthalmic lens (5) from the manufacturing line in case the ophthalmic lens (5) has been identified as having an unacceptable refractive power, but further processing the ophthalmic lens (5) in the manufacturing line in case the ophthalmic lens (5) has been identified as having an acceptable refractive power.

8. The method according to claim 1, further comprising the steps of:
providing a plurality of inspection cuvettes (2), each inspection cuvette (2) comprising an optically transparent bottom (21) having a concave inner surface (210) and containing an ophthalmic lens (5) immersed in a liquid, and positioning the plurality of inspection cuvettes (2) at the first inspection location (800) of the inspection module;
sequentially determining the refractive power of each of the ophthalmic lenses (5) contained in the plurality of inspection cuvettes (2).

9. The method according to claim 1, further comprising the step of:
after determination of the refractive power of the ophthalmic lens (5) or the ophthalmic lenses (5), moving the inspection cuvette (2) containing the ophthalmic lens or the plurality of inspection cuvettes containing the ophthalmic lenses from the first inspection location (800) to a second inspection location (900); and
at the second inspection location (900) performing an inline optical inspection of the ophthalmic lens (5) contained in the inspection cuvette (2) or of the ophthalmic lenses contained in the inspection cuvettes for the presence of other deficiencies.

10. The method according to claim 1, further comprising the steps of:
positioning the inspection cuvette (2) at a third inspection location (700) of the inspection module (1) for of the automated manufacturing line, for determination of the center thickness of the ophthalmic lens;
providing an interferometer (3) comprising a light source and a focusing probe (30), the focusing probe focusing light coming from the light source to a set position (310) of the ophthalmic lens at the center of the concave inner surface of the optically transparent bottom of the inspection cuvette (2), and the focusing probe (30) further directing light reflected at the boundary (510) between the back surface (51) of the ophthalmic lens and the liquid on the one hand as well as light reflected at the boundary (500) between the front surface (50) of the ophthalmic lens and the liquid or light reflected at the boundary (502) between the front surface (50) of the ophthalmic lens (5) and the concave inner surface (210) of the optically transparent bottom (21) of the inspection cuvette (2) on the other hand to a detector of the interferometer (3);
determining the center thickness (55) of the ophthalmic lens (5) from the signals generated at the detector of the interferometer by the light reflected at the respective boundary (510; 500,502) at the back surface (51) and at the front surface (50) of the ophthalmic lens (5).

11. The method according to claim 10, wherein the step of determining the center thickness (55) of the ophthalmic lens (5) comprises
in case the ophthalmic lens (5) rests on the concave inner surface (210) of the optically transparent bottom (21) of the inspection cuvette (2), selecting the signal generated by the light reflected at the boundary (502) between the front surface (50) of the ophthalmic lens and the concave inner surface (210) of the optically transparent bottom (21) of the inspection cuvette (2) as well as the signal generated by the light reflected at the boundary (510) between the back surface (51) of the ophthalmic lens (5) and the liquid;
in case the ophthalmic lens (5) is floating at a distance above the concave inner surface (210) of the optically transparent bottom (21) of the inspection cuvette (2), selecting the signal generated by the light reflected at the boundary (500) between the front surface (50) of the ophthalmic lens (5) and the liquid as well as the signal generated by the light reflected at the boundary (510) between the back surface (51) of the ophthalmic lens (5) and the liquid.

12. The method according to claim 10, wherein the step of determining the center thickness (55) of the ophthalmic lens (5) comprises
counting a number of signals generated by the light reflected at the respective boundary (510; 500,502) and
for a counted number of two signals, selecting the two signals for determining the center thickness (55) of the ophthalmic lens (5),
for a counted number of three signals, ignoring the signal corresponding to the light reflected at the boundary (200) between the concave inner surface (210) of the optically transparent bottom (21) of the inspection cuvette (2) and the liquid, and selecting the remaining two signals for determining the center thickness (55) of the ophthalmic lens (5).

13. The method according to claim 11, wherein the step of determining the center thickness (55) of the ophthalmic lens (5) comprises
counting a number of signals generated by the light reflected at the respective boundary (510; 500,502) and
for a counted number of two signals, selecting the two signals for determining the center thickness (55) of the ophthalmic lens (5),
for a counted number of three signals, ignoring the signal corresponding to the light reflected at the boundary (200) between the concave inner surface (210) of the optically transparent bottom (21) of the inspection cuvette (2) and the liquid, and selecting the remaining two signals for determining the center thickness (55) of the ophthalmic lens (5).

14. The method according to claim 10, further comprising the steps of:
comparing the determined center thickness (55) of the ophthalmic lens (5) with a predetermined set value for the center thickness; and
identifying the ophthalmic lens (5) as having an unacceptable center thickness if the determined center thickness (55) is outside a predetermined range of tolerance around the predetermined set value for the center thickness, or
identifying the ophthalmic lens (5) as having an acceptable center thickness if the determined center thickness (55) is within the predetermined range of tolerance around the predetermined set value for the center thickness; and
removing the ophthalmic lens (5) from the manufacturing line in case the ophthalmic lens has been identified as having an unacceptable center thickness (55), but further processing the ophthalmic lens (5) in the manufacturing line in case the ophthalmic lens (5) has been identified as having an acceptable center thickness (55).

15. The method according to claim 8, further comprising the steps of:
providing the plurality of inspection cuvettes (2) at the third inspection location (700) of the inspection module (1);
providing a plurality of focusing probes (30) corresponding to the plurality of inspection cuvettes (2), each of the focusing probes (30) focusing light to a set position (310) of the ophthalmic lens (5) at the center of the concave inner surface of the optically transparent bottom of a corresponding inspection cuvette (2), and each of the focusing probes (30) directing light reflected at the respective boundary (510; 500,502) at the back surface (51) and at the front surface (50) of the respective ophthalmic lens (5) to the detector of the interferometer (3); and
determining the center thickness (55) of each ophthalmic lens (5).

16. The method according to claim 15, wherein focusing light to the set position (310) of the ophthalmic lens (5) is performed sequentially for the plurality of inspection cuvettes (2) by directing light from the light source of the interferometer (3) via a first focusing probe (30) of the plurality of focusing probes to the set position (310) of the ophthalmic lens (5) contained in a first inspection cuvette (2) of the plurality of inspection cuvettes, subsequently directing light from the light source of the interferometer via a second focusing probe (30) to the set position of the ophthalmic lens (5) contained in a second inspection cuvette (2) of the plurality of inspection cuvettes, and so on, until light from the light source of the interferometer (1) is directed via a last focusing probe (30) of the plurality of focusing probes to the set position (310) of the ophthalmic lens (5) contained in a last inspection cuvette (2) of the plurality of inspection cuvettes.

17. The method according to claim 16, wherein sequentially focusing light to a set position (310) of the ophthalmic lens (5) for the plurality of inspection cuvettes (2) comprises
providing a plurality of deflectors (41₁, 41₂, 41₃, . . . , 41ₙ₋₁, 41ₙ) corresponding to the plurality of focusing probes (30), the individual deflectors of the plurality of deflectors (41₁, 41₂, 41₃, . . . , 41ₙ₋₁, 41ₙ) each being capable of being switched between an active state, in which the respective deflector (41₁, 41₂, 41₃, . . . , 41ₙ₋₁, 41ₙ) directs light coming from the light source of the interferometer to the corresponding focusing probe (30) and in which the respective deflector (41₁, 41₂, 41₃, . . . , 41ₙ₋₁, 41ₙ) directs light reflected at the respective boundary (510; 500,502) to the detector of the interferometer (3), and a passive state, in which the respective deflector allows the light coming from the light source to pass to the next deflector which is in the active state and which is arranged in an optical path of the light; and
sequentially switching a first deflector (41₁) of the plurality of deflectors (41₁, 41₂, 41₃, . . . , 41ₙ₋₁, 41ₙ) from the active state to the passive state after determining the center thickness (55) of the ophthalmic lens (5) contained in the first inspection cuvette (2), switching a second deflector (41₂) of the plurality of deflectors (41₁, 41₂, 41₃, . . . , 41ₙ₋₁, 41ₙ) from the active state to the passive state after determining the center thickness (55) of the ophthalmic lens (5) contained in the second inspection cuvette (2), and so on, until switching a second last deflector (41ₙ₋₁) of the plurality of deflectors (41₁, 41₂, 41₃, . . . , 41ₙ₋₁, 41ₙ) from the active state to the passive state after determining the center thickness (55) of the ophthalmic lens (5) contained in the second last inspection cuvette (2), and then determining the center thickness (55) of the ophthalmic lens contained in the last inspection cuvette (2) with the last deflector (41ₙ) being in the active state.

18. The method according to claim 15, further comprising the step of individually adjusting each focusing probe (30) of the plurality of focusing probes so as to focus light coming from the light source of the interferometer (3) to the corresponding set position (310) of the ophthalmic lens (5) at the center of the concave inner surface (210) of the optically transparent bottom (21) of the respective inspection cuvette (2) of the plurality of inspection cuvettes (2).

19. An automated manufacturing line for manufacturing ophthalmic lenses (5), the manufacturing line comprising:
a production module for manufacturing ophthalmic lenses (5);
an inspection module (1) for inspecting the manufactured ophthalmic lenses (5), the inspection module (1) comprising a wavefront sensor (6) comprising a detector (602), the wavefront sensor (6) being arranged at a first inspection location (800) and being capable of receiving light from a light source (42), for inspection of ophthalmic lenses (5) being contained in a plurality of inspection cuvettes (2), each inspection cuvette comprising an optically transparent bottom (21) and containing the ophthalmic lens (5) immersed in a liquid, and
wherein in operation the inspection module (1) performs the method according to claim 8.

20. The automated manufacturing line according to claim 19, wherein the inspection module (1) further comprises an interferometer (3) and a plurality of focusing probes (30) being arranged at a third inspection location (700) and being capable of being optically connected to the interferometer (3), for inspection of ophthalmic lenses (5) being contained in a plurality of inspection cuvettes (2) corresponding to the plurality of focusing probes (30), each inspection cuvette (2) comprising an optically transparent bottom (21) having a concave inner surface (210) and containing the ophthalmic lens (5) immersed in a liquid.
